(19) United States
(12) Patent Application Publication
(10) Pub. No.: US 2012/0173419 A1
(43) Pub. Date: Jul. 5, 2012

(54) VISUAL TRANSACTIONS

(75) Inventors: Karun Viswanath, Foster City, CA (US); Michael Cristofano Gioiella, San Jose, CA (US); Jason Jacobsen, Omaha, NE (US); Candido Blanco, San Francisco, CA (US)

(73) Assignee: eBay, Inc., San Jose, CA (US)

(21) Appl. No.: 12/983,095

(22) Filed: Dec. 31, 2010

(51) Int. Cl. G06Q 40/00

(52) U.S. Cl. 705/40

(57) ABSTRACT

Systems and methods for processing a transaction according to one or more embodiments comprise providing a visual representation of a transaction process on a user interface; receiving information about one or more actors and corresponding roles for each actor as part of the transaction from at least a portion of the user interface; receiving transaction information from the visual representation on the user interface; and performing an action for effecting the transaction process.

### BACKGROUND

1. Technical Field

Embodiments of the present disclosure generally relate to transactions, and more particularly, to methods and systems for transactions conducted via a user device with a visual user interface.

2. Related Art

In electronic commerce, a customer routinely searches for, purchases and pays for products and/or services from online merchants over communication networks, such as the Internet. In this regard, customers may frequently engage in transactions with a variety of merchants through, for example, various merchant websites. Routinely, customers engage in such transactions by using their mobile device. In some cases, a transaction may involve making payments to different parties split according to appropriate percentages. For example, a payment amount may have to be split between a general contractor, a sub-contractor and a supplier. However, typical ways of making payments that have to be split between different parties may not be apparent to an average customer using a mobile device. Accordingly, there is a need for a simple way of conducting transactions such as making split payments over a network so that they are apparent to the average customer.

### SUMMARY

As will be further described herein in relation to various embodiments, methods and systems for transactions conducted via a user device are provided such that a user may conduct transactions, e.g., making split payments for purchases and/or services (also referred to as adaptive payments) using a user device with a visual user interface.

In accordance with an embodiment of the disclosure, a method comprises providing a visual representation of a transaction process on a user interface; receiving information about one or more actors and corresponding roles for each actor as part of the transaction from at least a portion of the user interface; receiving transaction information from the visual representation on the user interface; and performing an action for effecting the transaction process.

In accordance with another embodiment of the disclosure, a client device includes a payment application loaded in the client device from a service provider server; one or more processors; and one or more memories adapted to store a plurality of machine-readable instructions which when executed by the one or more processors are adapted to cause the client device to: create a visual representation of a transaction process on a user interface of the client device by receiving inputs from a user via an interface of the client device to: add one or more actors and corresponding roles for each actor on at least a portion of the user interface; set up pre-approvals for actions to be performed; draw the transaction process on the user interface; and perform an action for effecting the transaction process.

In accordance with another embodiment of the disclosure, a system comprises a payment service provider server adapted to interact with a client device over a network; one or more processors; and one or more memories adapted to store a plurality of machine-readable instructions which when executed by the one or more processors are adapted to cause the system to: load a payment application on the client device wherein the client device is adapted to use the payment application to create a visual representation of a transaction process on a user interface of the client device; and receive, at the payment provider server, instructions for effecting the transaction process.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a block diagram illustrating a payment system using a payment service provider according to an embodiment of the present disclosure.

FIG. 2 is a block diagram illustrating a specific example for adaptive payments according to an embodiment of the present disclosure.

FIG. 3 is a sample screenshot for a payment process according to an embodiment of the present disclosure.

FIG. 4 is a flow diagram illustrating a method for creating a payment according to an embodiment of the present disclosure.

FIG. 5 is a block diagram of a system for implementing a device according to one embodiment of the present disclosure.

Like element numbers in different figures represent the same or similar elements.

### DETAILED DESCRIPTION

In accordance with various embodiments described herein, methods and systems are provided such that a user may easily work in an interactive environment enabling transaction functionality such as split payments for applications, products and/or services (also referred to as “adaptive payments”) over a user device with a visual user interface.

According to one or more embodiments, a user may visualize and easily conduct transactions including adaptive payments over a user interface of a user device. Any average user including, for example, a customer or a merchant, may easily conduct such transactions without the need for writing code. That is, any user without developer experience including non-tech savvy customers, business persons or merchants such as mechanics, event coordinators, or casual web developers may conduct transactions in a simple manner using a visual user interface. Also, a repository may be developed such that templates for recurring transactions may be saved for later use. Real time updates and notifications may also be provided.

In general, a payment application, which may be loaded on a user device by a payment service provider, enables a user to easily make payments on the user device. The payment application may be provided by a payment service provider such as PayPal and/or eBay of San Jose, Calif.

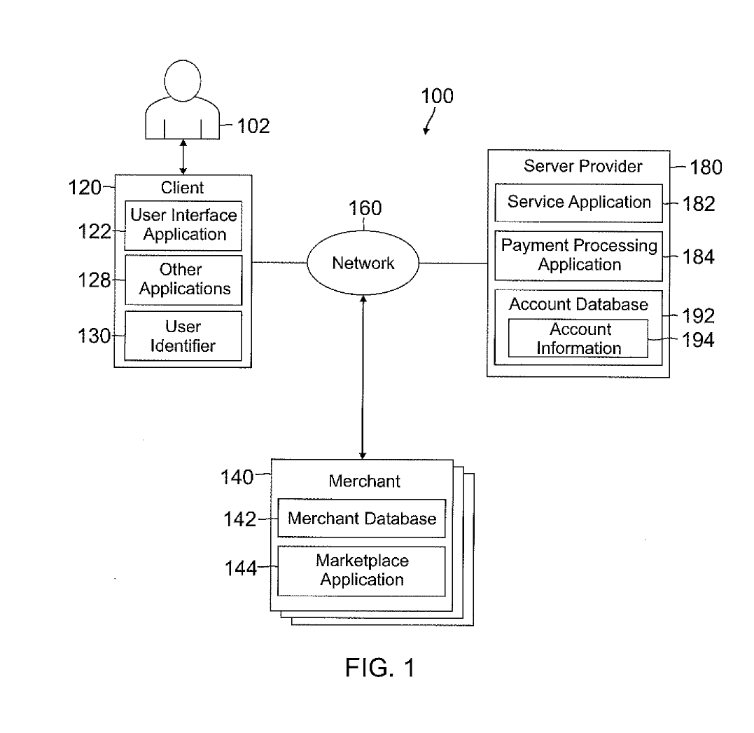

Referring now to the drawings wherein the showings are for purposes of illustrating embodiments of the present disclosure only, and not for purposes of limiting the same, FIG. 1 illustrates a block diagram of a payment system using a payment service provider according to an embodiment of the present disclosure.

FIG. 1 shows a block diagram of a system 100 adapted to facilitate transactions via a client device 120 over a network 160 according to an embodiment. As shown in FIG. 1, the system 100 includes at least one client device 120 (e.g., network computing device), one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a personal digital assistant (PDA), a personal computer, a notebook computer, and/or various other generally known types of wired and/or wireless computing devices. Other examples of client device 120 include a television set, a game console, a Digital Video Recorder (DVR), and potentially other devices such as microwaves, refrigerators, washing machines, etc. It should be appreciated that the client device 120 may also be referred to as a user device or a customer device without departing from the scope of the present disclosure.

The client device 120, in one embodiment, includes a user interface application 122, which may be utilized by the user 102 to conduct financial transactions (e.g., shopping, purchasing, bidding, etc.) with the service provider server 180 over the network 160. In one aspect, purchase expenses may be directly and/or automatically debited from an account related to the user 102 via the user interface application 122. In other aspects, the user interface application 122 may be used to visually set up a payment process involving, for example, adaptive payments, in a manner as described herein.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select applications, products, and/or services for purchase, and the user 102 is able to purchase applications, products, and/or services from the one or more merchant servers 140 via the service provider server 180. Also, the user 102 may conduct financial transactions (e.g., purchase, set up and provide payment for applications, products, and/or services) via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include a payment application that may be loaded on client device 120 by service provider server 180. Such payment application enables user 102 to easily set up a payment process or make payments for applications, products and/or services over client device 120 as will be described herein in further detail.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180.

The one or more merchant servers or devices 140, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various applications, products, and/or services for purchase and payment. It should be appreciated that embodiments of the present disclosure may be applicable to user-merchant, user-user, merchant-merchant and/or merchant-user transactions.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various applications, products, and/or services available for purchase in the merchant database 142.

As described in greater detail herein, the user 102 may conduct financial transactions (e.g., selection, monitoring, purchasing, and/or providing payment for applications, products, and/or services) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of applications, products, and/or services by the user 102 from one or more of the merchant servers 140. In one example, the service provider server 180 may be provided by PayPal, Inc. and/or eBay of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry and as described herein.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140).

The payment system described above with respect to the embodiment of FIG. 1 may be used to set up and facilitate payment options for a selected application, product and/or service using a client device including splitting payments between different parties or recipients (adaptive payments) as will be described in more detail below.

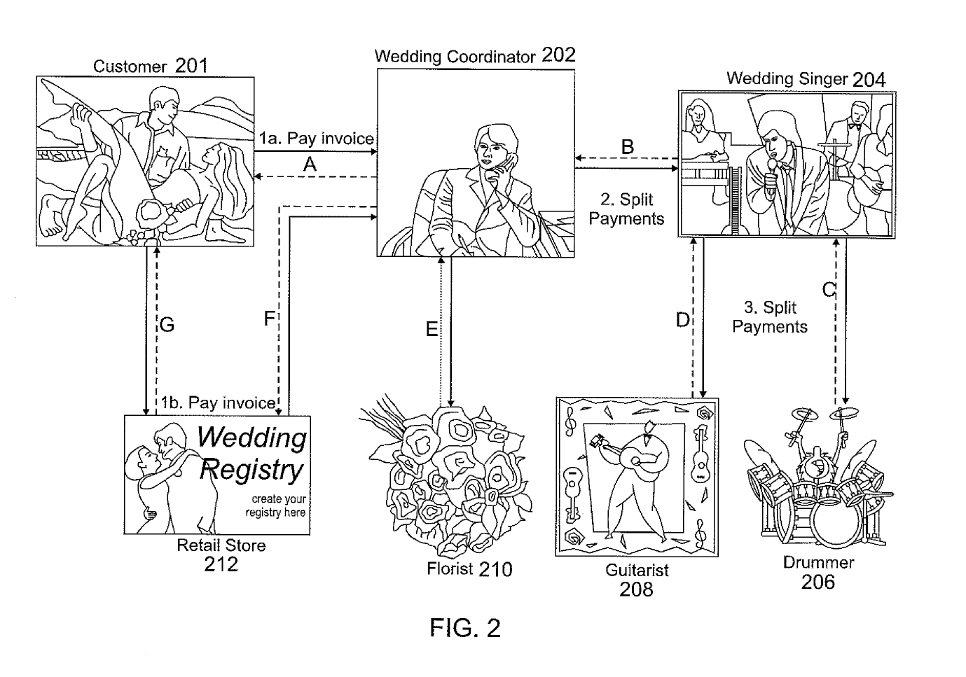

Referring now to FIG. 2, a block diagram illustrating a specific example for adaptive payments is shown according to an embodiment of the present disclosure. FIG. 2 may be implemented by the system of FIG. 1 according to one or more embodiments.

In the example of FIG. 2, user 102 may be a couple or a customer 201 wishing to plan a wedding. In that case, customer 201 hires a wedding coordinator 202 to help plan the wedding. Wedding coordinator 202, in turn, may hire different parties for the wedding including a wedding singer 204 and a florist 210. In this example, wedding singer 204 may in turn hire a drummer 206 and a guitarist 208 for the wedding.

As illustrated by arrow 1a, customer 201 makes a payment to wedding coordinator 202, for example, upon receiving an invoice from the wedding coordinator. The wedding coordinator 202 may then split the payment between multiple parties or recipients, including wedding singer 204 and florist 210 as indicated by reference number 2. Wedding singer 204, in turn, may further split the payment received from wedding coordinator 202 between other parties such as drummer 206 and guitarist 208 as indicated by reference number 3. It should be noted that payment amounts may be split between the parties according to agreed-upon or pre-negotiated percentages.

As indicated by arrow 1b, another split payment in this example may involve customer 201 making a payment to a merchant such as a retail store 212 for a wedding registry, for example, upon receiving an invoice from retail store 212. Retail store 212 may in turn make a payment to wedding coordinator 202 based on, for example, a commission or a pre-negotiated percentage.

It should be noted that the different parties may receive notifications acknowledging that payment has been made to a recipient as indicated by dashed arrows A, B, C, D, E, F and G, respectively. For example, an Instant Payment Notification (IPN), which allows online merchants to handle real-time purchase confirmation and sewer-to-server communication, may be used. In general, service provider server 180 may notify a specified URL, which points to an IPN script to process payment notifications.

Split (or adaptive) payments according to one or more embodiments described herein may be made to one or more parties or receivers (which may include entities such as a merchant, partner, marketplace, etc.) in different ways to accommodate various situations including, for example, use cases of commissions, revenue share marketplace, etc. Although FIG. 2 illustrates a wedding coordinator example, there are many other examples where split payments may be involved.

In addition, it should be appreciated that there are different ways in which adaptive or split payments may take place, for example, a payment amount may be split in chain (or sequential) order, in parallel order, in chain plus parallel order, in parallel plus chain order or in any permutation combining one or more of a chain order and a parallel order.

Embodiments of a chain split payment system may apply to situations wherein a merchant server 140 (or partner) shares part of the payment amount with other players, for example, in a marketplace wherein the merchant server 140 (or partner) posts items that belong to other parties, or in other cases, for example, wherein the payment is to be split between several receivers, for example, a merchant, the developer of the application, product and/or service, and a service provider. A specific example for use of a chain split payment system includes commission payments wherein, for example, a business entity pays employees a commission payment based on sales completed. In the wedding coordinator example of FIG. 2, a chain split payment is involved where customer 201 pays wedding coordinator 202 and wedding coordinator 202, in turn, pays wedding singer 204 and florist 210.

A parallel split payment may apply to situations when a merchant server 140 (or partner) shares part of the payment amount with other parties, for example, in a marketplace where a merchant server 140 (or partner) posts items that belong to other parties. An example for use of a parallel split payment system includes situations where two or more simultaneous business relationships take place. In the wedding coordinator example of FIG. 2, a parallel split payment is involved where wedding singer 204 splits his or her payment amount to pay drummer 206 and guitarist 208.

A payment amount may be split between different receivers first in a chain split payment system and then in a parallel split payment system. In the wedding coordinator example of FIG. 2, first a chain split payment is involved where a payment amount from customer 201 is made to wedding coordinator 202 who in turn makes a payment according to a pre-arranged percentage to wedding singer 204. Then, a second a parallel split payment is involved where wedding singer 204 splits his or her payment amount in parallel to pay drummer 206 and guitarist 208.

In a parallel plus chain split payment system according to an embodiment, a payment amount submitted by user 102 may be split between different receivers first in a parallel split system and then in a chain split system. In the wedding coordinator example of FIG. 2, first a parallel split payment may be involved if customer 201 were to make parallel payments to wedding coordinator 202 and retail store 212 according to pre-arranged percentages. Then, a chain split payment is involved where wedding coordinator 202 makes a payment to florist 210.

An API call, for example, may be placed by an appropriate calling party including a merchant, a marketplace or application operator, a client device manufacturer, a carrier, etc., to provide instructions on how to split a payment amount between one or more parties or receivers to effectuate the payment. Once the API call providing payment instructions is made, the user's account may be debited and the one or more receivers are paid accordingly.

As described above according to one or more embodiments, a payment amount may be split in chain (or sequential) order, in parallel order or in any permutation combining one or more of a chain order and a parallel order. To effectuate appropriate payment, the payment service provider, for example, may be caused to debit the user's account with the payment service provider and to credit each receiver's account with the payment service provider according to the payment instructions received in the API call.

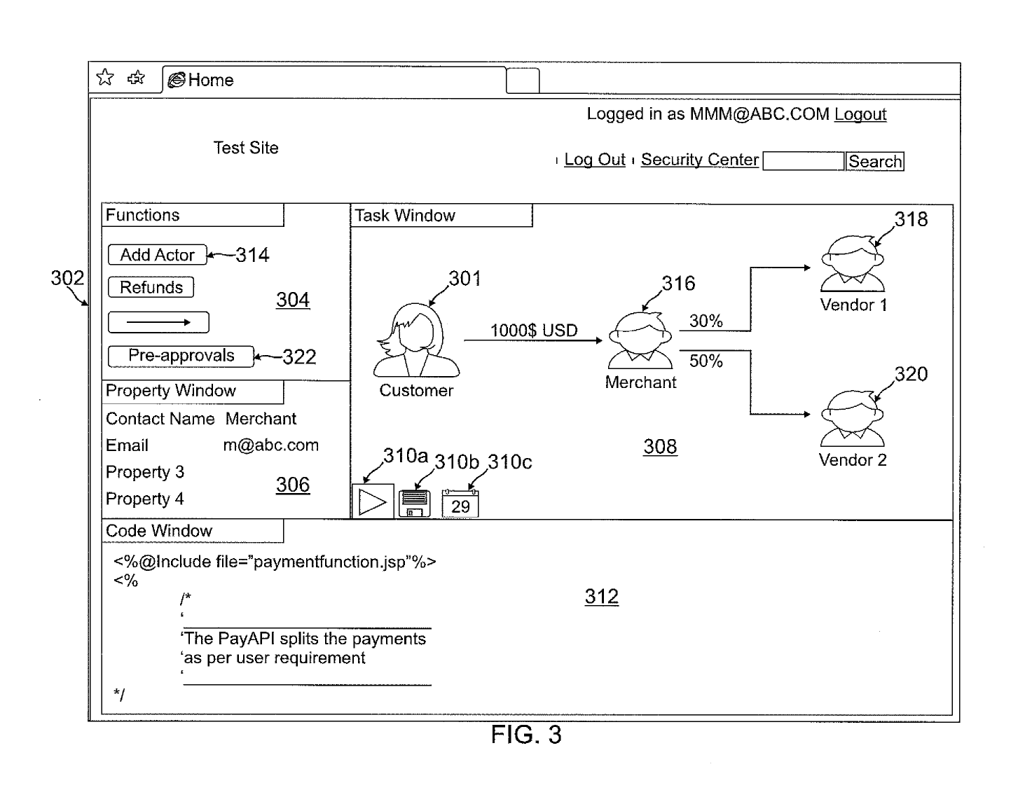

Referring now to FIG. 3, a sample screenshot for a payment process is illustrated according to an embodiment of the present disclosure. According to one or more embodiments, FIG. 3 may be implemented by a user device such as client device 120 or merchant server or device 140 of FIG. 1.

In one or more embodiments, a user interface 302 may be implemented by a user device where a screen shot therein includes a visual representation of a split or adaptive payment. In various embodiments, user interface 302 may illustrate a screen shot of a website on a computing device. In the embodiment of FIG. 3, a payment process is illustrated wherein payments are split visually according to user requirements. It should be noted that embodiments herein may apply to any adaptive payment including, for example, chain payments, parallel payments or any permutation combining at least one of a chain payment and a parallel payment as described above.

The sample screen shot of user interface 302 illustrates different options for a user including: choosing functions in a Functions window 304, configuring properties in a Property window 306, drawing a payment process in Task window 308, performing an action by any of icons 310a, 310b or 310c, or automatically generating code in Code window 312.

In Functions window 304, user interface 302 provides an option to add one or more actors for the payment process and to create a corresponding role for each of the one or more actors, for example, a role may include the role of a customer or a merchant. One or more actors may be added, for example, by selecting an interface such as a button 314 labeled “Add Actor” or any other appropriate label. By selecting an interface such as button 314, a role may also be chosen such as the role of a “customer” or the role of a “merchant”. The role of a “customer” may correspond to an end client looking for an application, a service and/or a product. The role of a “merchant” may correspond to a provider of an application, a service and/or a product. In this embodiment, by selecting button 314, customer 301, merchant 316 and vendors 318 and 320 may be added with a respective role (e.g., a customer or a merchant).

Functions window 302 may also include an interface such as a button 322 labeled “Pre-approvals” or having any other appropriate label. By selecting button 322, a user may choose a function to be performed including for example, sending money (i.e., paying for an application, product and/or service), authorizing a payment, or creating a pre-approval agreement such as for recurring payments.

Property window 306 allows a user to configure properties, for example, contact name, information as well as other information about each actor may be set in property window 306.

Task window 308 is a visual representation of a drawn payment process, which includes the users and functions to be performed. For example, by selecting button 314 in Functions window 304, actors are added such as a customer 301, a merchant 316 and vendors 318 and 320, which are assigned corresponding roles. It should be noted that according to one or more embodiments, each actor may be represented in task window 308 as an avatar, an icon or any other suitable symbol. In various embodiments, the avatar, icon or other suitable symbol may be selected, for example from symbols that may be available in Functions window 302, and dragged and dropped into Task window 308.

By selecting button 322, a payment amount may be pre-approved from customer 301 to merchant 316, for example, a $1000 payment amount. Also, a payment amount may be authorized to be split between one or more actors according to assigned percentages. For example, vendor 318 may be authorized to receive 30% of the payment amount and vendor 320 may be authorized to receive 50% of the payment amount from merchant 16. Specifically, customer 301 authorizes a payment amount of $1000 to be made to merchant 316 such that vendor 318 gets paid $300 (30% of $1000) and vendor 320 gets paid $500 (50% of $1000), leaving merchant 16 with the remaining amount of $200.

It should be appreciated that the payment amount, actors, and their respective percentages described in this embodiment are for illustration purposes only and any number of actors in any role or any payment amount or split percentages may be used within the scope of this disclosure according to one or more embodiments.

Optionally, once a payment process is drawn as in Task window 308, the system may provide feedback based on the reasonableness of the drawn payment process. For example, the system may indicate that an amount may not be adequate or customary. In some instances, a payment may be inadequate because of a likely mistake or the amount being too small or too large. That is, if a payment amount of $1000 appears to be low in comparison to previous payments, the system may provide feedback indicating a potential payment deficiency. In another example, if one of vendors 318 or 320 is unhappy or unsatisfied with the corresponding percentage of the payment amount, the vendor could provide feedback of the potential inadequacy of the vendor's corresponding payment amount.

Upon all actors being satisfied with their corresponding payment amount, an action may be performed by selecting an interface as illustrated, for example, by buttons 310a, 3101) or 310c. The user may perform an action including, for example, executing payment by selecting button 310a, or saving the drawn payment process as a template by selecting button 310b, or scheduling a payment for a later time or date by selecting button 310c.

Selecting an interface such as button 310b so that the drawn payment process of Task window 308 is saved as a template such as in a repository may be useful in embodiments where, for example, there are recurring events involving the same actors. For instance, in the wedding coordinator example of FIG. 2, wedding planner 202 may use a saved template for different wedding events for different customers because wedding planner 202 may work with the same vendors such as wedding singer 204 and florist 210. In other words, wedding coordinator 202 may re-use such a template for multiple weddings without having to create or draw a new payment process for each wedding or each customer.

It should be noted that the drawn payment process may also be used for a one-time user or payment or as a standalone payment process for a particular segment.

In addition to performing actions as discussed above, Code window 312 provides an option to automatically generate code. For example, code may be generated for the user or for a particular website. In one or more embodiments, code may be used in social media websites such as Facebook so that payments are generated through such websites.

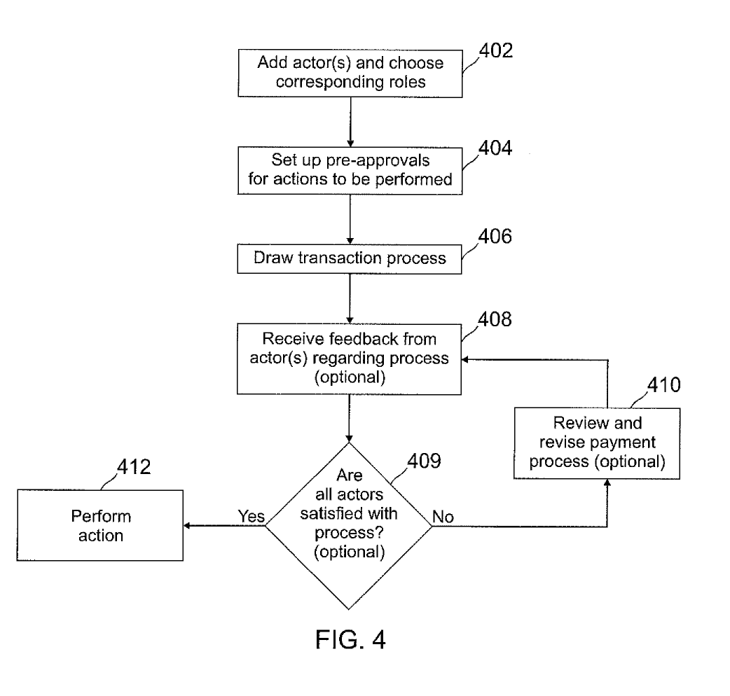

Referring now to FIG. 4, a flow diagram is illustrated of a method for creating a payment according to an embodiment of the present disclosure. The method of FIG. 4 may be implemented on user interface 302 of FIG. 3 according to an embodiment of the present disclosure.

In block 402, one or more actors are added and corresponding roles are chosen for each actor, for example, roles may be chosen as a “user” corresponding to an end client looking for an application, a service and/or a product, or as a “merchant” corresponding to a provider of an application, a service and/or a product.

In block 404, pre-approvals are set up, that is, functions to be performed are authorized, for example, to: send money (i.e., pay for a product and/or service); authorize a payment; or create a pre-approval agreement such as for recurring payments.

In block 406, a transaction process is drawn reflecting the role of each actor and the relationship therebetween. For example, a transaction process may involve a payment amount to be split between different actors at pre-determined percentages.

In block 408, optionally, the one or more actors may review different aspects of the payment process such as the payment amounts corresponding to each actor based on, for example, amount of previous payments, past performance or prior history. The one or more actors may provide feedback regarding the payment process.

In block 409, if an actor is not satisfied, for example, because a payment amount is not adequate or is not customary, feedback may be provided regarding inadequacies of the process such as the inadequacy of the payment amount. The system then returns to block 410 for potential corrections or clarifications and review.

In block 412, once all the actors are satisfied, the user performs an action including, for example, executing a payment, saving the transaction process as a template, or scheduling a payment for a later time.

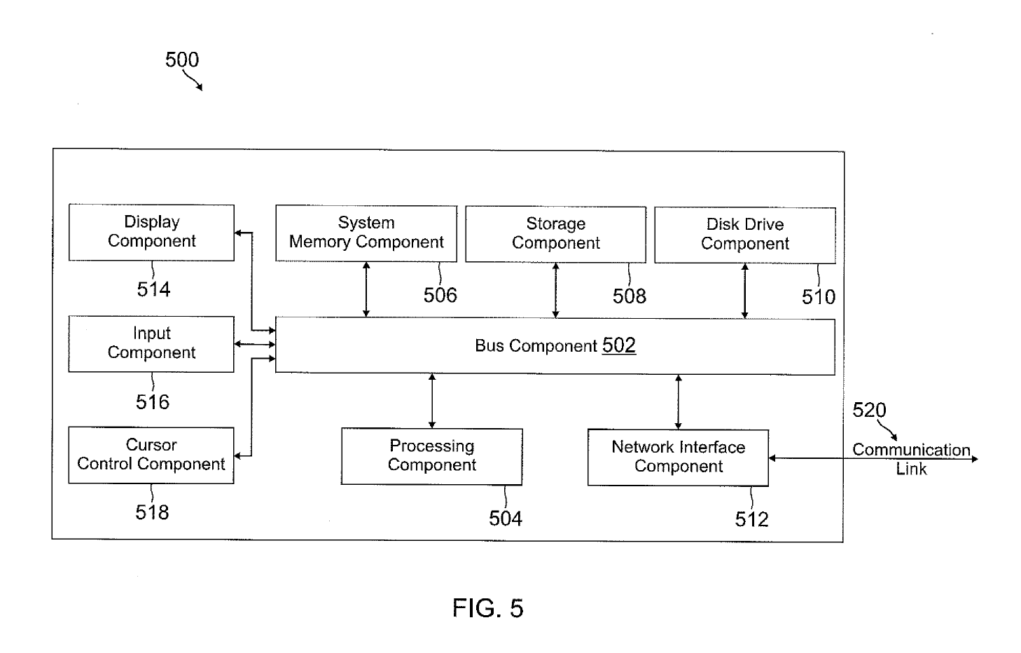

FIG. 5 is a block diagram of a system 500 suitable for implementing embodiments of the present disclosure, including client device 120, one or more merchant servers or devices 140, and service provider server or device 180. System 500, such as part of a cell phone, personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to process financial transactions, make payments, split payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In one embodiment, the computer readable medium is non-transitory. In various implementations, volatile media includes dynamic memory, such as system memory component 506, and transmission media includes coaxial cables, copper wire, and fiber optics, including wires that comprise bus 502. Memory may be used to store visual representations of the different options for payments or financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., network 160 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for visualizing adaptive payments allowing any user to accomplish such payment processes.

Although various components and steps have been described herein as being associated with client device 120, merchant server 140, and payment service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A method for processing a transaction comprising:
providing a visual representation of a transaction process on a user interface;
receiving information about one or more actors and corresponding roles for each actor as part of the transaction from at least a portion of the user interface;
receiving transaction information from the visual representation on the user interface; and
performing an action for effecting the transaction process.

2. The method of claim 1, wherein the transaction process comprises splitting a payment amount between the one or more actors according to instructions provided for splitting the payment amount.

3. The method of claim 2, wherein the instructions are received via an API call.

4. The method of claim 2 wherein a user's account is debited and accounts of the one or more actors are credited in predetermined percentages according to the instructions.

5. The method of claim 2, wherein the payment amount is split between the one or more actors in a chain order, a parallel order or in a combination of at least one of a chain and a parallel order.

6. The method of claim 1 wherein the performing an action further comprises executing the transaction process, saving the transaction process as a template or performing the transaction process at a later time.

7. The method of claim 6 wherein the executing the transaction process further comprises facilitating a payment for an application, goods and/or services.

8. The method of claim 1, further comprising automatically generating code for the transaction process.

9. The method of claim 1, further comprising receiving information on configuring properties for the transaction process.

10. The method of claim 1, further comprising receiving information on making payments for applications, goods and/or services, authorizing a payment and/or creating a pre-approved agreement for recurring payments.

11. The method of claim 1, further comprising providing real-time updates or notifications regarding a transaction.

12. The method of claim 1, further comprising receiving feedback from the one or more actors regarding the transaction process.

13. The method of claim 12, wherein if the feedback received indicates that the one or more actors are unsatisfied with the transaction process, receiving information on further reviewing and revising of the transaction process.

14. A client device comprising:
a payment application loaded in the client device from a service provider server;
one or more processors; and
one or more memories adapted to store a plurality of machine-readable instructions which when executed by the one or more processors are adapted to cause the client device to:
create a visual representation of a transaction process on a user interface of the client device by receiving inputs from a user via an interface of the client device to:
add one or more actors and corresponding roles for each actor on at least a portion of the user interface;
set up pre-approvals for actions to be performed;
draw the transaction process on the user interface; and
perform an action for effecting the transaction process.

15. The client device of claim 14, wherein the transaction process further comprises splitting a payment amount between the one or more actors according to instructions provided for splitting the payment amount.

16. The client device of claim 14 further comprising a wireless telephone, a personal digital assistant (PDA), a personal computer, or a notebook computer.

17. A system comprising:
a payment service provider server adapted to interact with a client device over a network;
one or more processors; and
one or more memories adapted to store a plurality of machine-readable instructions which when executed by the one or more processors are adapted to cause the system to:
load a payment application on the client device wherein the client device is adapted to use the payment application to create a visual representation of a transaction process on a user interface of the client device; and
receive, at the payment provider server, instructions for effecting the transaction process.

18. The system of claim 17, wherein the plurality of machine-readable instructions which when executed by the one or more processors are further adapted to cause the system to: receive, at the payment service provider server, instructions for the transaction process including making a payment for an application, product and/or service selected by a user over the client device, wherein the payment is split between one or more actors according to instructions provided to the payment service provider over the network.

19. The system of claim 18, wherein the payment is split between the one or more actors in a sequential order, a parallel order, a chain plus parallel order or a parallel plus chain order.

20. The system of claim 18 wherein the instructions are received via an API call.
